(19) United States
(12) Patent Application Publication
(10) Pub. No.: US 2025/0091089 A1
(43) Pub. Date: Mar. 20, 2025

(54) ULTRASONIC TRANSDUCER AND METHOD OF FABRICATING THE SAME

(71) Applicant: Qisda Corporation, Taoyuan City (TW)

(72) Inventor: Fu-Sheng Jiang, Taoyuan City (TW)

(73) Assignee: Qisda Corporation, Taoyuan City (TW)

(21) Appl. No.: 18/806,713

(22) Filed: Aug. 16, 2024

(30) Foreign Application Priority Data
Sep. 14, 2023 (TW) 112134991

(51) Int. Cl. B06B 1/06

(52) U.S. Cl. CPC B06B 1/0629; B06B 1/0662

(57) ABSTRACT

Disclosed is an ultrasonic transducer including a substrate and multiple ultrasonic transducer units. The substrate has an ultrasonic transceiver area. The ultrasonic transducer units, each including a first electrode, multiple first cavities and a second electrode, are arranged at intervals on the substrate along a first direction. The first electrode and the first cavities, which overlap the first electrode, are disposed in the ultrasonic transceiver area. The first cavities are arranged at intervals along a second direction. The second electrode extends on the first cavities along the second direction, overlapping the first electrode and the first cavities. The second electrode is electrically-insulated from the first electrode. The second electrode has a first width along the first direction in the ultrasonic transceiver area, and the first width of the second electrode remains fixed or unchanged along the second direction. A method of fabricating the ultrasonic transducer is also provided.

### CROSS-REFERENCE TO RELATED APPLICATION

This application claims the priority benefit of Taiwan application serial no. 112134991, filed on Sep. 14, 2023. The entirety of the above-mentioned patent application is hereby incorporated by reference herein and made a part of this specification.

### BACKGROUND

### Technical Field

The present disclosure relates to a transducer and a method of fabricating the same, and in particular to an ultrasonic transducer and a method of fabricating the same.

### Description of Related Art

Ultrasonic transducers are transducers that realize the conversion between acoustic energy and electrical energy within the ultrasonic frequency range. Ultrasonic transducers are primarily categorized into three types: transmitters, receivers, and transceivers. Transducers used for transmitting ultrasound are known as transmitters, which, in the transmitting state, convert electrical energy into mechanical energy, and subsequently into acoustic energy. Transducers used for receiving sound waves are known as receivers, which, in the receiving state, convert acoustic energy into mechanical energy, and subsequently into electrical energy. In some cases, transducers serve as both transmitters and receivers, hence being referred to as transceivers. Transceivers are the core and one of the key technologies in the field of ultrasonic technology. Transceivers are widely applied in fields including non-destructive testing, medical imaging, ultrasonic microscopy, fingerprint recognition, and the Internet of Things (IoT).

To achieve better operational bandwidth, a method utilizing a sacrificial layer in conjunction with etching technologies to form vibratory cavities has been proposed. As the sacrificial layer is also covered by a driving electrode layer, the driving electrode layer must have holes for the etching of the sacrificial layer. Further, due to the limitations in the capacity of the etching process, there cannot be overlarge intervals between the holes on the driving electrode layer, resulting in the need of adopting a series-parallel design for the conducting wire structure in the driving electrode layer in the ultrasonic transceiver area. However, such wiring design creates a substantial difference between the overall line width and the signal wire in the wiring area. The difference leads to ineffective reflections on the interface between the signal wire and the conducting wire, causing a reduction in the sensitivity of the ultrasonic transducer.

### SUMMARY

The disclosure provides an ultrasonic transducer with improved operational sensitivity.

The disclosure also provides a method for fabricating an ultrasonic transducer, through which the ultrasonic transducers made have enhanced sensitivity and operational bandwidth.

An ultrasonic transducer of the disclosure includes a substrate and a plurality of ultrasonic transducer units. The substrate has an ultrasonic transceiver area. The ultrasonic transducer units, each including a first electrode, a plurality of first cavities and a second electrode, are arranged on the substrate at intervals along a first direction. The first electrode and the first cavities, which overlap the first electrode, are disposed in the ultrasonic transceiver area. The first cavities are arranged at intervals along a second direction, which intersects the first direction. The second electrode extends on the first cavities along the second direction, overlapping the first electrode and the first cavities. The second electrode is electrically-insulated from the first electrode. The second electrode has a first width along the first direction in the ultrasonic transceiver area, and the first width of the second electrode remains fixed or unchanged along the second direction.

A method of fabricating an ultrasonic transducer of this disclosure includes forming a first electrode and a plurality of first cavities on a substrate as well as forming a second electrode on the first cavities. The ultrasonic transducer includes a plurality of ultrasonic transducer units, each of which encompasses a first electrode, a plurality of first cavities, and a second electrode overlapping with one another. The ultrasonic transducer units are arranged at intervals along a first direction, and the first cavities are arranged at intervals along a second direction, which intersects the first direction. The second electrode extends along the second direction and is electrically insulated from the first electrode. The second electrode has a first width along the first direction, and the first width of the second electrode remains fixed or unchanged along the second direction.

Based on the above, in an ultrasonic transducer in an embodiment of the disclosure, each of a plurality of ultrasonic transducer units arranged at intervals along a first direction in an ultrasonic transceiver area of a substrate includes a first electrode, a plurality of first cavities, and a second electrode, with the first electrode, the plurality of first cavities, and the second electrode overlapping with one another. The first cavities are arranged at intervals along a second direction. The second electrode extending on the first cavities has a first width along the first direction. As the first width of the second electrode remains constant along its extension direction, ineffective interface reflections are effectively controlled during the transmission of an electrical signal within the second electrode, contributing to the enhancement of the sensitivity of the ultrasonic transducer.

### BRIEF DESCRIPTION OF THE DRAWINGS

FIG. 1 is a schematic diagram of a front view of an ultrasonic transducer according to a first embodiment of this disclosure.

FIG. 2 is a magnified schematic diagram of a partial area of the ultrasonic transducer in FIG. 1.

FIG. 3 is a cross-sectional schematic diagram of the ultrasonic transducer in FIG. 2.

FIG. 4A to FIG. 4E are cross-sectional schematic diagrams for the fabricating process of the ultrasonic transducer in FIG. 3.

FIG. 5 is a schematic diagram of a front view of an ultrasonic transducer according to a second embodiment of the disclosure.

FIG. 6 is a schematic diagram of a front view of an ultrasonic transducer according to a third embodiment of the disclosure.

FIG. 7 is a schematic diagram illustrating a front view of an ultrasonic transducer according to a fourth embodiment of the disclosure.

FIG. 8 is a cross-sectional schematic diagram of the ultrasonic transducer in FIG. 7.

FIG. 9A to FIG. 9C are sectional schematic diagrams illustrating the fabricating process of the ultrasonic transducer in FIG. 8.

FIG. 10 is a schematic diagram of a front view of an ultrasonic transducer according to

a fifth embodiment of the disclosure.

### DESCRIPTION OF THE EMBODIMENTS

The terms “about,” “approximately,” “essentially,” and “substantially” used herein include both a given value and an average, within an acceptable deviation range, of specific values determined by a person having ordinary skill in the art, taking into account a specific number of measurement errors and measurement-related errors, that is, limitations of a measurement system. For example, “about” may be interpreted to mean one or more standard deviations of a given value, or a range within 30%, 20%, 15%, 10% or 5% of the given value. Furthermore, “about,” “approximately,” “essentially,” and “substantially” used herein allows for the selection of a more acceptable deviation range or standard deviation according to measurement properties, cutting properties, or other properties without adhering to a standard deviation for all properties.

In the accompanying drawings, thicknesses of layers, films, panels, areas, etc., are exaggerated for clarity. It is understood that when an element, such as a layer, film, area, or substrate, is described as being “on” or “connected to” another element, the element may be directly on or directly connected to the another element, and an intermediate element may be present. Conversely, when an element is described as being “directly on” or “directly connected to” another element, there is no intermediate element. The terms “connection” or “connect” used herein relate to physical and/or electrical connections. Furthermore, “electrical connection” may involve other elements between the two elements.

In addition, relative terms such as “lower” or “bottom” and “upper” or “top” are utilized herein to describe the relationship of an element to another element, as illustrated in the drawings. It is understood that these relative terms are used for the purpose of including different orientations of the device other than the orientations depicted in the drawings. For example, if a device in a drawing. is flipped over, an element described as being on the “lower” side of another element will then be oriented on the “upper” side of the another element. Therefore, the exemplary term “lower” may encompass both an orientation of “lower” and “upper”, depending on the particular orientation of the drawing. Similarly, if a device in a drawing is flipped over, an element described as being “below” or “underneath” another element will then be oriented as being “above” the another element. The exemplary terms “above” or “below” may, therefore, encompass both an orientation of above and below.

The following detailed description refers to the exemplary embodiments of the disclosure with instances in the accompanying drawings. Wherever possible, the same reference signs are used in the drawings and the description to refer to the same or similar portions.

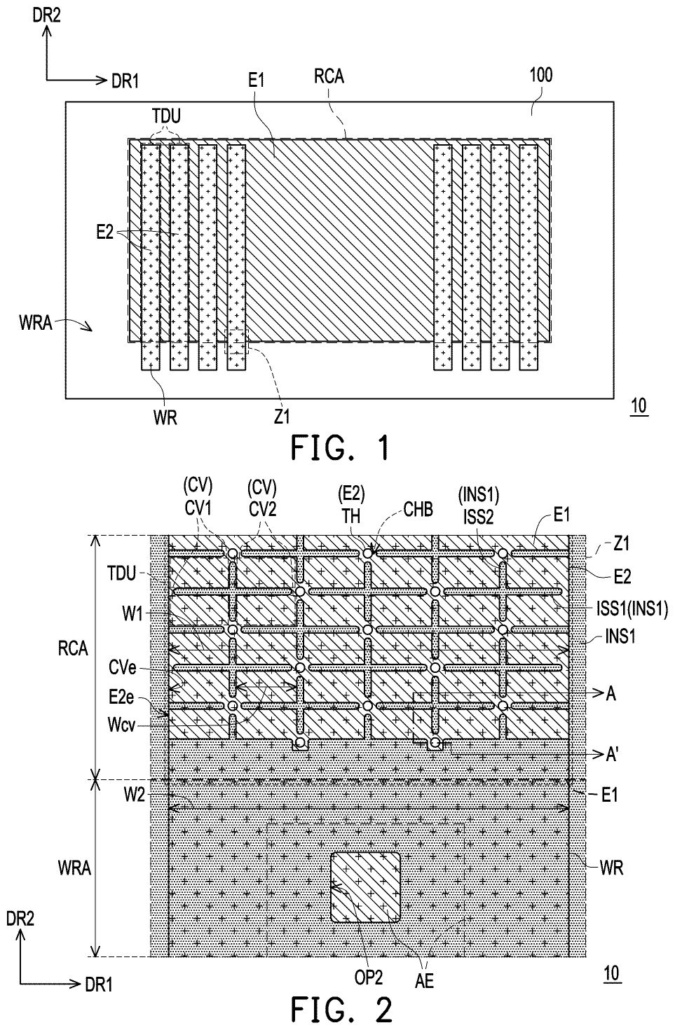

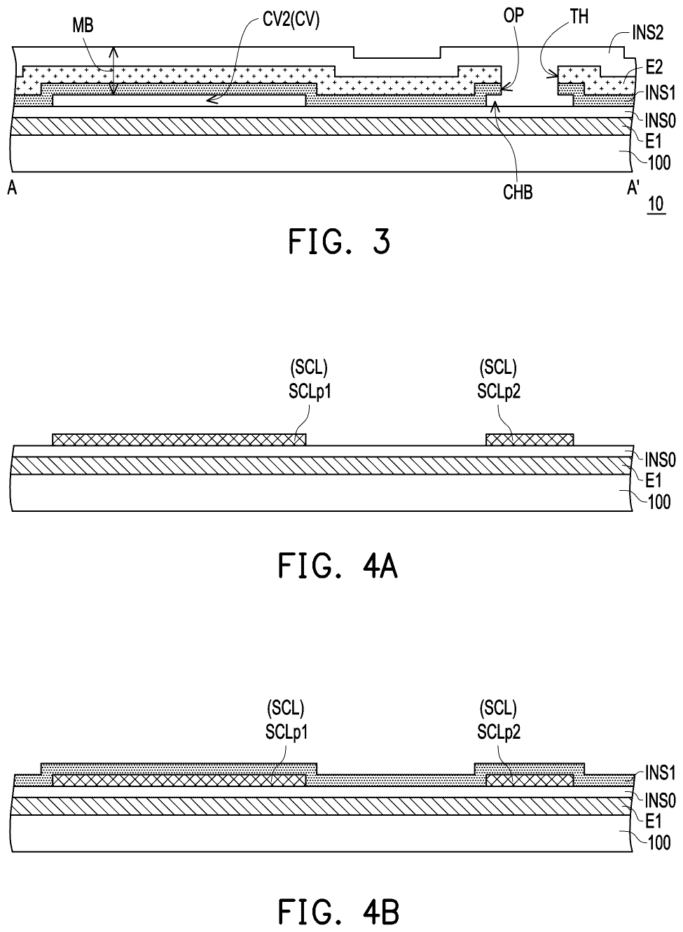

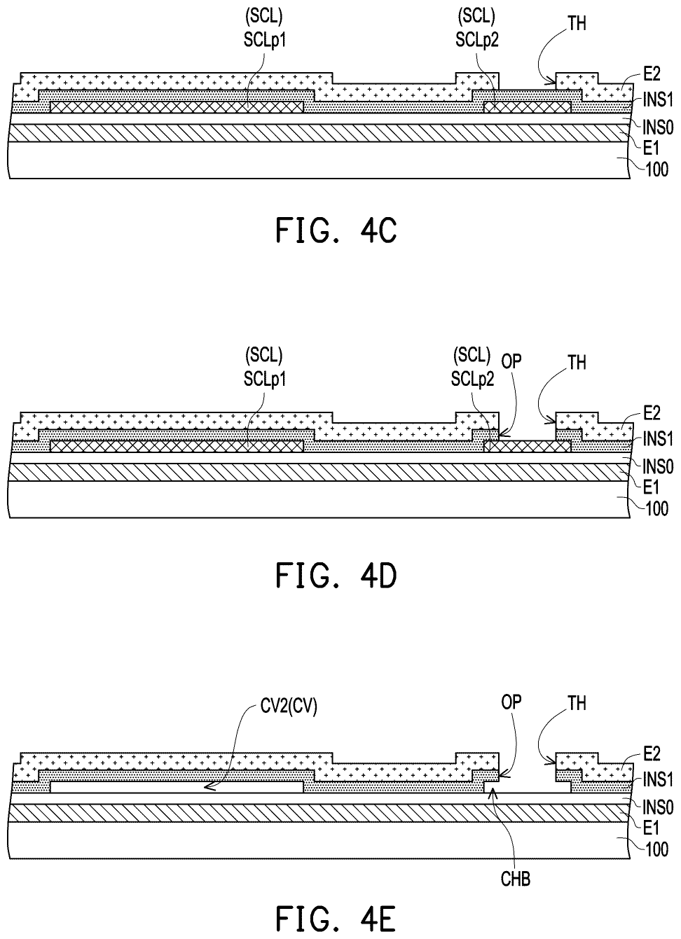

FIG. 1 is a schematic diagram of a front view of an ultrasonic transducer according to a first embodiment of this disclosure. FIG. 2 is a magnified schematic diagram of a partial area of the ultrasonic transducer in FIG. 1. FIG. 3 is a cross-sectional schematic diagram of the ultrasonic transducer in FIG. 2. FIG. 4A to FIG. 4E are cross-sectional schematic diagrams for the fabricating process of the ultrasonic transducer in FIG. 3. FIG. 2 shows a partial area Z1 of FIG. 1. FIG. 3 corresponds to the sectional line A-A′ in FIG. 2. It is noted that in the following content, any mention of overlap or non-overlap of two members is defined based on the overlap or non-overlap of the orthogonal projections of the two members on a substrate 100.

Please refer to FIG. 1 and FIG. 2. An ultrasonic transducer 10 includes a substrate 100 and a plurality of ultrasonic transducer units TDU. The ultrasonic transducer units TDU are disposed in an ultrasonic transceiver area RCA on the substrate 100, each including a first electrode E1, a second electrode E2, and a plurality of cavities CV.

In this embodiment, the ultrasonic transducer units TDU are arranged at intervals along a first direction DR1 in the ultrasonic transceiver area RCA on the substrate 100 and extend along a second direction DR2. The first direction DR1 intersects with the second direction DR2, for example, perpendicularly. The first electrode E1 is entirely disposed in the ultrasonic transceiver area RCA, as shown in FIG. 1, but is not limited to this disposition. A plurality of cavities CV are disposed in the ultrasonic transceiver area RCA, overlapping the first electrode E1. More specifically, an orthogonal projection of the area occupied by the cavities CV on the substrate 100 falls within another orthogonal projection of the first electrode E1 on the substrate 100. In other words, the cavities CV overlap entirely with the first electrode E1 along the normal direction of a surface of the substrate 100.

In this embodiment, the plurality of cavities CV of an ultrasonic transducer unit TDU are a combination including but not limited to, for example, a plurality of first cavities CV1 and a plurality of second cavities CV2. The first cavities CV1 are arranged at intervals along the second direction DR2, forming a plurality of strings of the first cavities. The second cavities CV2 are also arranged at intervals along the second direction DR2, forming a plurality of strings of the second cavities. The strings of the first cavities and the strings of the second cavities are alternately arranged along the first direction DR1 and are separated from one another. That is, a plurality of the first cavities CV1 and a plurality of the second cavities CV2 are arranged at intervals and alternately along the first direction DR1.

The second electrode E2 extends along the second direction DR2 on the plurality of first cavities CV1 and the plurality of second cavities CV2, and overlaps the first electrode E1, the plurality of first cavities CV1, and the plurality of second cavities CV2. More specifically, an orthogonal projection of the area occupied by the first cavities CV1 and the second cavities CV2 on the substrate 100 falls within another orthogonal projection of the second electrode E2 on the substrate 100. In other words, the cavities CV overlap entirely with the second electrode E2 along the normal direction of a surface of the substrate 100. The second electrode E2 and the first electrode E1 are electrically insulated from each other.

In this embodiment, the second electrode E2 has a first width W1 in the ultrasonic transceiver area RCA along the first direction DR1. Each of the plurality of cavities CV (e.g., the first cavities CV1 and the second cavities CV2) has a cavity width Wcv along the first direction DR1. The first width W1 of the second electrode E2 may exceed the cavity width Wcv. For example, the ratio of the first width W1 of the second electrode E2 to the cavity width Wcv may be greater than 6, which indicates that the number of cavity strings overlapping or being covered by the second electrode E2 may be, but not limited to, six. In other embodiments that are not presented in the drawings, the second electrode may also cover one cavity string, that is, the first width of the second electrode E2 may be equal to the cavity width Wcv of the cavities CV.

On the other hand, in this embodiment, two edges E2e of the second electrode E2 in the first direction DR1 may align with edges CVe of the outermost cavities CV, but this is not a limitation. According to the embodiment, the second electrode E2 has a plurality of through-holes TH, and the through-holes TH do not overlap with the plurality of first cavities CV1 and the plurality of second cavities CV2. For example, the through-holes TH of the second electrode E2 and the plurality of cavities CV may be alternately arranged along the first direction DR1 or the second direction DR2.

It is noted that in this embodiment, the range of distribution of the cavities CV of the ultrasonic transducer 10 are defined by using a sacrificial layer SCL (as shown in FIG. 4D). The cavities CV are also formed with the sacrificial layer SCL in conjunction with an etching technology. In terms of the etching process yield, when using the current technology, different cavity strings must be disconnected from one another for the second electrode, adopting a series-parallel structural design. This results in a significant difference between an overall width of the second electrode within the range of distribution of the cavity strings and a signal wire width in a wiring area. Furthermore, widths of portions of the second electrode overlapping a same cavity string vary periodically along the extension direction of the cavity string. Both the significant difference between the signal wire width and the width of the second electrode and the periodic variation in the width of the second electrode along the extension direction of the cavity string lead to ineffective interface reflections and energy loss during the transmission of an electrical signal through the connected signal wire and second electrode.

In this embodiment, the first width W1 of the second electrode E2 in the ultrasonic transceiver area RCA remains fixed or unchanged along the second direction, which is the extension direction of the second electrode E2. In other words, the second electrode E2 not only covers the plurality of cavities CV, but also covers areas between the cavities CV. This means that a plurality of portions of the second electrode E2 overlapping the plurality of cavity strings are interconnected, which allows for a significant reduction in the creation of ineffective interface reflections when transmitting electrical signals through the second electrode E2, thereby improving the sensitivity of the ultrasonic transducer 10.

Further, in this embodiment, the substrate 100 also includes a wiring area WRA, which is located outside the ultrasonic transceiver area RCA. In the wiring area WRA, a signal wire WR extending from the second electrode E2 is disposed. That is, the signal wire WR and the second electrode E2 are formed in a same film layer. A second width W2 of the signal wire WR along the first direction DR1 equals the first width W1 of the second electrode E2 in the ultrasonic transceiver area RCA. This disposition, therefore, prevents ineffective interface reflections when an electrical signal passes through the connection between the second electrode E2 and the signal wire WR, further improving the sensitivity of the ultrasonic transducer 10.

Please refer to FIG. 2 and FIG. 3. An ultrasonic transducer unit TDU also encompasses an insulation layer INS0, an insulation layer INS1, and an insulation layer INS2. The insulation layer INS1 is disposed between the first electrode E1 and the second electrode E2, while the insulation layer INS0 is disposed between the insulation layer INS1 and the first electrode E1. The insulation layer INS1 includes a plurality of openings OP, and the openings OP overlap with the plurality of through-holes TH of the second electrode E2. In other words, the openings OP of the insulation layer INS1 are not overlapped with the plurality of cavities CV as well. The insulation layer INS2 is disposed on the second electrode E2 and filled in the through-holes TH of the second electrode E2 and the openings OP of the insulation layer INS1. In this embodiment, the insulation layer INS0, the insulation layer INS1, and the insulation layer INS2 are, for example, passivation layers, with materials such as but not limited to silicon nitride, silicon oxide, silicon carbide, or aluminum oxide.

On the other hand, the insulation layer INS1 has an interval segment ISS1 that separates any two adjacent first cavities CV1 or any two adjacent second cavities CV2, and an interval segment ISS2 separating any adjacent first cavity CV1 and second cavity CV2. The orthogonal projections of these interval segments ISS1 and ISS2 of the insulation layer INS1 on the substrate 100 fall within the orthogonal projection of the second electrode E2 (or the first electrode E1) on the substrate 100.

That is, in the insulation layer INS1, portions between the plurality of cavities CV are generally arranged in a grid layout, and each orthogonal projection of these cavities CV on the substrate 100 is shaped in the form of a rectangle, though not exclusively so. In other embodiments, an orthogonal projection of a cavity on a substrate 100 may be square, rectangular, oval, circular, hexagonal, or any other suitable shape.

In the embodiment, the portions of the second electrode E2, the portions of the insulation layer INS1, and the portions of the insulation layer INS2 above the cavities CV form a vibratable membrane MB of the ultrasonic transducer 10. In this embodiment, the ultrasonic transducer 10 is, e.g., a capacitive micromachined ultrasonic transducer (CMUT).

For example, the first electrode E1 is electrically coupled to a reference power source (e.g., a ground). The second electrode E2 above the cavities CV is electrically coupled to a DC power source and an AC power source, with an output voltage of the DC power source as the reference bias voltage. Upon receiving the bias voltage from the DC power source and a voltage from the AC power source, the second electrode E2 causes the vibratable membrane MB to vibrate, generating an ultrasonic signal.

In this embodiment, as the first electrode E1 is entirely disposed in the ultrasonic transceiver area RCA, an overlapping portion of the first electrode E1 and the second electrode E2 outside the disposition area of the plurality of the cavities CV also allows for an additional storage capacitance. Sufficient storage capacitance allows for controlling a level shift in the reference bias voltage caused by losses of DC electric charges on the second electrode E2. In other words, the additional storage capacitance from the overlapping portion of the first electrode E1 and the second electrode E2 outside the area covered by the cavities CV enhances the operational stability of the ultrasonic transducer 10 driven by a DC-coupled signal and an AC-coupled signal.

A description of exemplary embodiments with respect to a fabrication method of an ultrasonic transducer 10 is provided below. Please refer to FIG. 4A. Initially, a first electrode E1, an insulation layer INS0, and a sacrificial layer SCL are sequentially formed on a substrate 100. The first electrode E1 is usually made of a metallic material due to conductivity considerations, but this is not a limitation. The material for the sacrificial layer SCL is, e.g., aluminum (Al), gold (Au), copper (Cu), or silicon dioxide (SiO2). Subsequently, an insulation layer INS1 is formed on the sacrificial layer SCL, covering the sacrificial layer SCL and a portion of the insulation layer INS0, as shown in FIG. 4B.

Please refer to FIG. 2 and FIG. 4C. A second electrode E2 is formed on the insulation layer INS1. The second electrode E2 has a plurality of through-holes TH, which overlap the sacrificial layer SCL. For conductivity considerations, the second electrode E2 is made of a metallic material, but this is not a limitation.

Then, as shown in FIG. 4D, a portion of the insulation layer INS1 is removed through the plurality of through-holes TH of the second electrode E2 to form a plurality of openings OP. In this embodiment, these openings OP aligns with the plurality of through-holes TH of the second electrode E2 respectively. However, this is not a limitation for the disclosure. In other embodiments, a plurality of through-holes TH of a second electrode E2 and a plurality of openings OP of an insulation layer INS1 may be formed in a same etching process.

Please refer to FIG. 4D and FIG. 4E. The sacrificial layer SCL is then removed through the through-holes TH of the second electrode E2 and the openings OP of the insulation layer INS1 to form cavities CV, such as first cavities CV1 or second cavities CV2 shown in FIG. 2. It is noted that, although not shown in FIG. 4C, the sacrificial layer SCL not only has a first portion SCLp1 for defining the cavities CV, but also has a second portion SCLp2 extending from the first portion SCLp1 and overlapping the through-holes TH of the second electrode E2. During the etching process of the sacrificial layer SCL, the second portion SCLp2 is removed before the first portion SCLp1. On the other hand, the aforementioned first cavities CV1 and second cavities CV2 are formed simultaneously in a same etching process of the sacrificial layer SCL.

Therefore, after the etching process is completed, the through-holes TH of the second electrode E2 only overlap with chambers CHB defined by the second portion SCLp2 of the sacrificial layer SCL. The through-holes TH of the second electrode E2 do not overlap the cavities CV defined by the first portion SCLp1 of the sacrificial layer SCL. In this embodiment, the plurality of cavities CV connect one another through a plurality of chambers CHB overlapping the through-holes TH of the second electrode E2. From another perspective, after removing the sacrificial layer SCL, a plurality of interval segments (e.g., an interval segment ISS1 and an interval segment ISS2, as shown in FIG. 2) separating the cavities CV in the insulation layer INS1 are revealed.

Please refer to FIG. 4E and FIG. 3. Subsequently, an insulation layer INS2 is formed on the second electrode E2. The insulation layer INS2 is filled in the through-holes TH of the second electrode E2, the openings OP of the insulation layer INS1, and a portion of the chambers CHB overlapping the through-holes TH. With this, the fabrication of the ultrasonic transducer 10 in this embodiment is completed.

In this embodiment, the ultrasonic transducer 10 may also include an auxiliary electrode AE disposed in a wiring area WRA. The auxiliary electrode AE and the first electrode E1 are formed in a same film layer but are electrically separated from each other. In other words, the auxiliary electrode AE in the wiring area WRA is structurally separated from the first electrode E1 in an ultrasonic transceiver area RCA. A signal wire WR within the wiring area WRA overlaps the auxiliary electrode AE, and is electrically connected to the auxiliary electrode AE through an opening OP2 on the insulation layer INS0 and the insulation layer INS1. The disposition of the auxiliary electrode AE enhances the conductivity of the signal wire WR in the wiring area WRA, or, in other words, reduces the transmission impedance of the signal wire WR in the wiring area WRA.

Some other embodiments are provided below to describe the disclosure in detail. In these embodiments, members mentioned before are designated with the same or similar symbols, and descriptions of the same or similar technical content are omitted. The omitted content will not be reiterated in the following description; please refer to the previously mentioned embodiments.

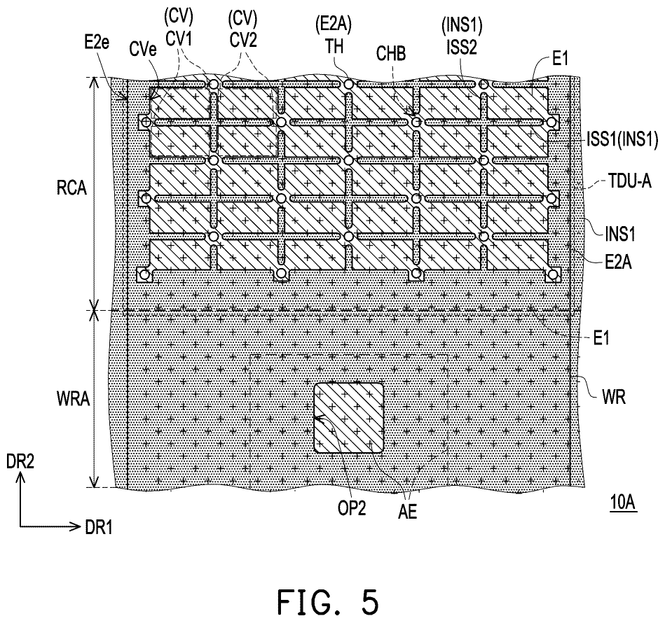

FIG. 5 is a schematic diagram of a front view of an ultrasonic transducer according to a second embodiment of the disclosure. Please refer to FIG. 5. A difference between an ultrasonic transducer 10A in this embodiment and an ultrasonic transducer 10 in FIG. 2 lies in the disposition of a second electrode. For example, in this embodiment, a second electrode E2A of an ultrasonic transducer unit TDU-A may extend from the portion overlapping a plurality of cavities CV to both sides along a first direction DR1.

That is, in this embodiment, two edges E2e of the second electrode E2A in the first direction DR1 do not respectively align with an edge CVe of an outermost cavity CV. With this disposition, not only the tolerance of the process, the storage capacitance of the ultrasonic transducer 10A is increased, further enhancing the operational stability of the ultrasonic transducer 10A driven by a DC-coupled signal and an AC-coupled signal.

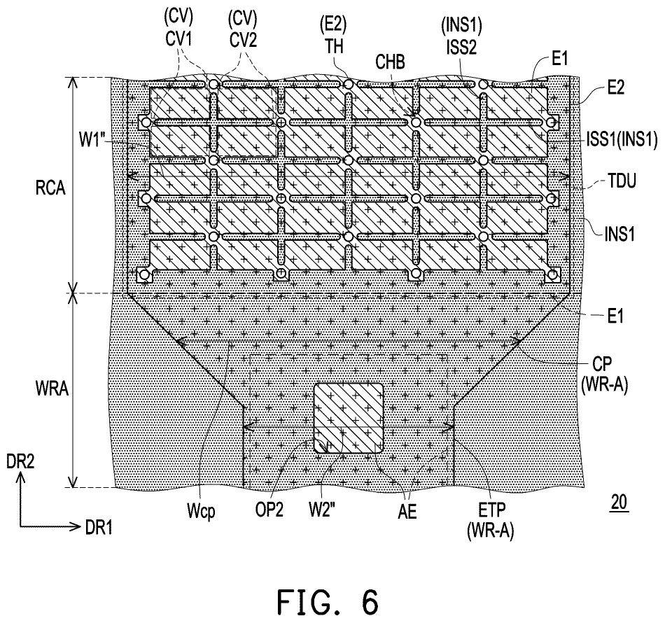

FIG. 6 is a schematic diagram of a front view of an ultrasonic transducer according to a third embodiment of the disclosure. Please refer to FIG. 6. A difference between an ultrasonic transducer 20 in this embodiment and an ultrasonic transducer 10A in FIG. 5 lies in the disposition of a signal wire in a wiring area. For example, in this embodiment, a signal wire WR-A has an extension portion ETP and a connecting portion CP. The connecting portion CP connects the extension portion ETP to a second electrode E2 in an ultrasonic transceiver area RCA.

It is noted that the extension portion ETP of the signal wire WR-A along a first direction DR1 has a second width W2″, and the second width W2″ is smaller than a first width W1″ of a second electrode E2 along the first direction DR1. A width Wcp of the connecting portion CP of the signal wire WR-A along the first direction DR1 tapers from an end connected to the second electrode E2 to another end connected to the extension portion ETP. In other words, in this embodiment, an integrated design and a tapered wire width is adopted for the connection between the signal wire WR-A and the second electrode E2, thereby reducing the risk of creating ineffective interface reflections when an electrical signal passes through the connection between the second electrode E2 and the signal wire WR-A.

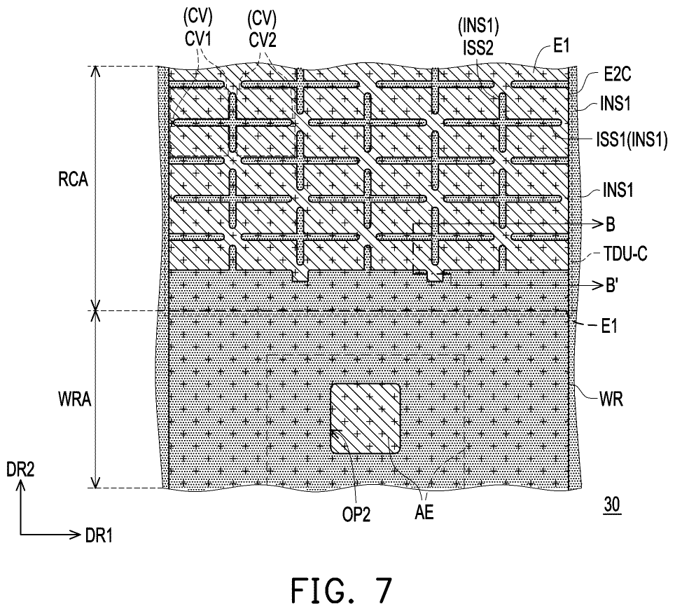

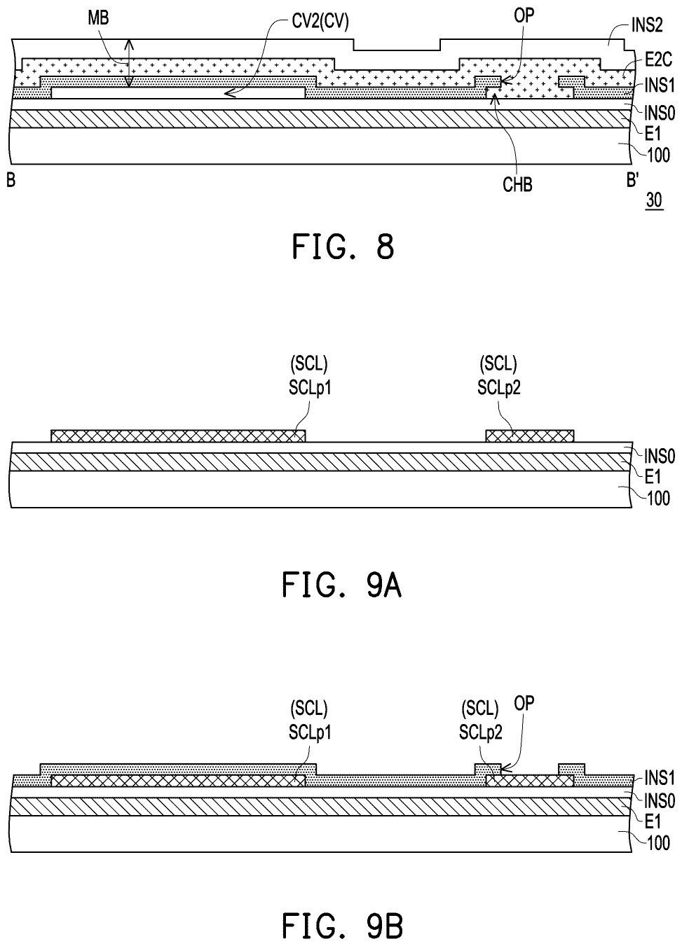

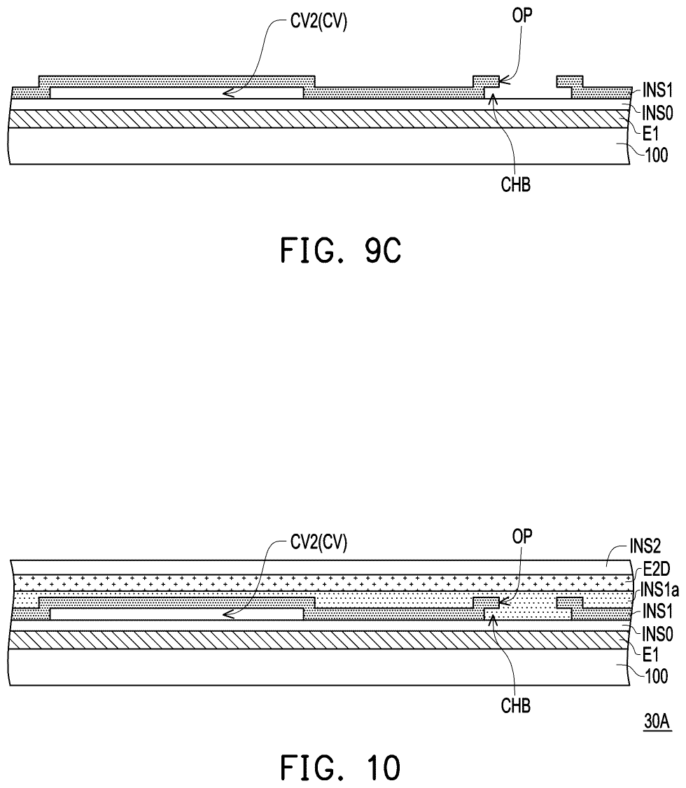

FIG. 7 is a schematic diagram illustrating a front view of an ultrasonic transducer according to a fourth embodiment of the disclosure. FIG. 8 is a cross-sectional schematic diagram of the ultrasonic transducer in FIG. 7. FIG. 9A to FIG. 9C are sectional schematic diagrams illustrating the fabricating process of the ultrasonic transducer in FIG. 8. FIG. 10 is a schematic diagram of a front view of an ultrasonic transducer according to a fifth embodiment of the disclosure. FIG. 8 corresponds to the sectional line B-B′ in FIG. 7.

Please refer to FIG. 7 and FIG. 8. A difference between an ultrasonic transducer 30 in this embodiment and an ultrasonic transducer 10 in FIG. 2 lies in the design of a second electrode. For example, in the ultrasonic transducer 30 in this embodiment, a second electrode E2C of an ultrasonic transducer unit TDU-C does not have a plurality of through-holes TH as seen in a second electrode E2 in FIG. 2. From another perspective, in this embodiment, the second electrode E2C fills a plurality of openings OP in an insulation layer INS1 (as shown in FIG. 8). The difference results from a variation in the fabrication method.

A description of a fabrication method of the ultrasonic transducer 10 in this exemplary embodiment is provided below. Please refer to FIG. 9A. Initially, a first electrode E1, an insulation layer INS0, and a sacrificial layer SCL are sequentially formed on a substrate 100. The first electrode E1 is made of a metallic material due to conductivity considerations, but this is not a limitation. The material for the sacrificial layer SCL is, e.g., aluminum (Al), gold (Au), copper (Cu), or silicon dioxide (SiO2).

Subsequently, an insulation layer INS1 is formed on the sacrificial layer SCL, covering the sacrificial layer SCL and a portion of the insulation layer INS0, as shown in FIG. 9B. It is noted that, different from the fabricating process (FIG. 4B to FIG. 4D) of an ultrasonic transducer 10 in FIG. 2, before the formation of a second electrode E2C in the ultrasonic transducer 30 in this embodiment, openings OP are already formed in the insulation layer INS1. The sacrificial layer SCL is also removed before the formation of the second electrode E2C.

Please refer to FIG. 9B and FIG. 9C. Continued from the previous paragraph, in other words, the formation of a plurality of cavities CV is achieved by removing the sacrificial layer SCL through the plurality of openings OP in the insulation layer INS1. Finally, the second electrode E2C and an insulation layer INS2 are sequentially formed on the insulation layer INS1, with the second electrode E2C filling the plurality of openings OP of the insulation layer INS1, as shown in FIG. 8.

However, the above is not a limitation for the disclosure. For an ultrasonic transducer 30A in FIG. 10, the fabrication method may also include forming an insulation layer INS1a on an insulation layer INS1 before the formation of a second electrode E2D. The insulation layer INS1a fills a plurality of openings OP and a portion of chambers CHB in the insulation layer INS1, thereby improving the smoothness of surfaces of the subsequently formed second electrode E2D and insulation layer INS2. In this embodiment, the material of the insulation layer INS1a and the material of the insulation layer INS1 may be the same, though not exclusively so.

In summary, in an ultrasonic transducer in an embodiment of the disclosure, each of a plurality of ultrasonic transducer units arranged at intervals along a first direction in an ultrasonic transceiver area of a substrate includes a first electrode, a plurality of first cavities, and a second electrode, with the first electrode, the plurality of first cavities, and the second electrode overlapping with one another. The first cavities are arranged at intervals along a second direction. The second electrode extending on the first cavities has a first width along the first direction. As the first width of the second electrode remains constant along its extension direction, ineffective interface reflections are effectively controlled during the transmission of an electrical signal within the second electrode, contributing to the enhancement of the sensitivity of the ultrasonic transducer.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An ultrasonic transducer, comprising:
a substrate having an ultrasonic transceiver area; and
a plurality of ultrasonic transducer units arranged at intervals along a first direction on the substrate, one of the plurality of ultrasonic transducer units comprising:
a first electrode disposed in the ultrasonic transceiver area;
a plurality of first cavities disposed in the ultrasonic transceiver area and overlapping the first electrode, the plurality of first cavities being arranged at intervals along a second direction which intersects the first direction; and
a second electrode extending on the plurality of first cavities along the second direction, the second electrode overlapping the first electrode and the plurality of first cavities, being electrically insulated from the first electrode, and having a first width along the first direction in the ultrasonic transceiver area, wherein the first width of the second electrode remains fixed or unchanged along the second direction.

2. The ultrasonic transducer of claim 1, wherein one of the plurality of first cavities has a cavity width along the first direction, and the first width of the second electrode is greater than or equal to the cavity width.

3. The ultrasonic transducer of claim 1, wherein the second electrode comprises a plurality of through-holes, and the plurality of through-holes are not overlapped with the plurality of first cavities.

4. The ultrasonic transducer of claim 3, wherein the plurality of through-holes and the plurality of first cavities are alternately arranged along the second direction.

5. The ultrasonic transducer of claim 3, wherein the one of the plurality of ultrasonic transducer units further comprises:
a first insulation layer disposed between the first electrode and the second electrode, the first insulation layer having a plurality of openings, the plurality of openings overlapping the plurality of through-holes of the second electrode respectively; and
a second insulation layer disposed on the second electrode, the second insulation layer filling the plurality of through-holes of the second electrode and the plurality of openings in the first insulation layer.

6. The ultrasonic transducer of claim 1, wherein the one of the plurality of ultrasonic transducer units further comprises an insulation layer, the insulation layer being disposed between the first electrode and the second electrode, wherein the insulation layer has a plurality of openings that are not overlapped with the plurality of first cavities, and the second electrode fills the plurality of openings of the insulation layer.

7. The ultrasonic transducer of claim 1, wherein orthogonal projections of the plurality of first cavities on the substrate fall within an orthogonal projection of the second electrode on the substrate.

8. The ultrasonic transducer of claim 1, wherein the one of the plurality of ultrasonic transducer units further comprises an insulation layer, the insulation layer being disposed between the first electrode and the second electrode and having an interval segment that separates any two of the plurality of first cavities adjacent to each other, wherein an orthogonal projection of the interval segment on the substrate falls within an orthogonal projection of the second electrode on the substrate.

9. The ultrasonic transducer of claim 1, wherein the substrate further comprises a wiring area outside the ultrasonic transceiver area, the wiring area comprising a signal wire extending from the second electrode, the signal wire having a second width along the first direction, wherein the second width is less than or equal to the first width.

10. The ultrasonic transducer of claim 9, wherein the signal wire comprises:
an extension portion connected to the second electrode; and
a connecting portion connected to the extension portion, wherein a width of the connecting portion along the first direction tapers from one end connected to the second electrode to another end connected to the extension portion.

11. The ultrasonic transducer of claim 1, wherein the one of the plurality of ultrasonic transducer units further comprises:
a plurality of second cavities being disposed in the ultrasonic transceiver area, and overlapping the first electrode, the plurality of second cavities being arranged at intervals along the second direction, wherein the plurality of first cavities and the plurality of second cavities are arranged at intervals along the first direction, with orthogonal projections of the plurality of second cavities on the substrate falling within an orthogonal projection of the second electrode on the substrate.

12. The ultrasonic transducer of claim 11, wherein the one of the plurality of ultrasonic transducer units further comprises an insulation layer, the insulation layer being disposed between the first electrode and the second electrode and having at least one interval segment that separates the plurality of first cavities from the plurality of second cavities, wherein an orthogonal projection of the at least one interval segment on the substrate falls within an orthogonal projection of the second electrode on the substrate.

13. A method of fabricating an ultrasonic transducer, wherein the ultrasonic transducer comprises a plurality of ultrasonic transducer units, one of the plurality of ultrasonic transducer units comprising a first electrode, a plurality of first cavities, and a second electrode overlapped with one another, wherein the plurality of ultrasonic transducer units are arranged at intervals along a first direction and the plurality of first cavities are arranged at intervals along a second direction which intersects the first direction, the method of fabricating the ultrasonic transducer comprising:
forming the first electrode and the plurality of first cavities on a substrate; and
forming the second electrode on the plurality of first cavities, wherein the second electrode extends along the second direction, is electrically insulated from the first electrode, and has a first width along the first direction, the first width of the second electrode remaining fixed or unchanged along the second direction.

14. The method of fabricating the ultrasonic transducer of claim 13, wherein forming the plurality of first cavities comprises:
forming a sacrificial layer on the first electrode; and
removing the sacrificial layer through a plurality of through-holes of the second electrode to form the plurality of first cavities, wherein the plurality of through-holes of the second electrode are not overlapped with the plurality of first cavities.

15. The method of fabricating the ultrasonic transducer of claim 14, further comprising:
forming a first insulation layer on the sacrificial layer;
removing a portion of the first insulation layer through the plurality of through-holes of the second electrode to form a plurality of openings before removing the sacrificial layer; and
forming a second insulation layer on the second electrode, the second insulation layer filling the plurality of through-holes of the second electrode and the plurality of openings of the first insulation layer.

16. The method of fabricating the ultrasonic transducer of claim 13, wherein forming the plurality of first cavities comprises:
forming a sacrificial layer on the first electrode;
forming an insulation layer with a plurality of openings on the sacrificial layer; and
removing the sacrificial layer through the plurality of openings of the insulation layer to form the plurality of first cavities, wherein the second electrode is formed on the insulation layer and fills the plurality of openings.

17. The method of fabricating the ultrasonic transducer of claim 13, wherein forming the plurality of first cavities comprises:
forming a sacrificial layer on the first electrode;
forming an insulation layer on the sacrificial layer; and
removing the sacrificial layer to form the plurality of first cavities to reveal a plurality of interval segments in the insulation layer that separate the plurality of first cavities, wherein orthogonal projections of the plurality of interval segments on the substrate fall within an orthogonal projection of the second electrode on the substrate.

18. The method of fabricating the ultrasonic transducer of claim 13, wherein the one of the plurality of ultrasonic transducer units further comprises a plurality of second cavities arranged at intervals along the second direction, the plurality of first cavities and the plurality of second cavities being arranged at intervals along the first direction, the method of fabricating the ultrasonic transducer further comprising:
forming the plurality of second cavities while forming the plurality of first cavities, wherein the plurality of second cavities overlap the first electrode and the second electrode.

19. The method of fabricating the ultrasonic transducer of claim 18, wherein forming the plurality of first cavities and the plurality of second cavities comprises:
forming a sacrificial layer on the first electrode;
forming an insulation layer on the sacrificial layer; and
removing the sacrificial layer to form the plurality of first cavities and the plurality of second cavities to reveal a plurality of interval segments in the insulation layer that separate the plurality of first cavities from the plurality of second cavities, wherein orthogonal projections of the plurality of intervals on the substrate fall within an orthogonal projection of the second electrode on the substrate.
